(19) United States
(12) Patent Application Publication
(10) Pub. No.: US 2026/0304377 A1
(43) Pub. Date: Oct. 1, 2026

(54) INDOOR POSITIONING ENHANCEMENT USING EXCLUSION MASK

(71) Applicant: QUALCOMM Incorporated, San Diego, CA (US)

(72) Inventor: Benjamin TARLOW, Cambridge (GB)

(21) Appl. No.: 19/089,134

(22) Filed: Mar. 25, 2025

(51) Int. Cl. H04W 64/00; G01S 11/06

(52) U.S. Cl. CPC H04W 64/006; G01S 11/06

(57) ABSTRACT

Determining a position of a user equipment (UE) in an indoor environment, includes: determining predicted positions for the UE; for at least one a given predicted position, determining intermediate propagation position(s) (IPP) between a previous position and the given predicted position, where the IPP(s) represent a straight-line trajectory between the previous position and the given predicted position; determining cell(s) of a position estimation exclusion mask that correspond to the IPP(s) and the given predicted position, where each cell of the exclusion mask corresponds to an area in the environment, where each cell includes a first indication based on the area including obstacle(s) or a second indication based on the area not including an obstacle; removing the given predicted position from the predicted positions based on at least one of the cell(s) including the first indication; and determining the position of the UE based on the remaining predicted positions.

### BACKGROUND

Devices, such as mobile devices, may move within an indoor environment that may include a mixture of structured areas and open areas based on the locations of various obstacles. In indoor navigation, positions of devices, such as mobile devices, may be determined using terrestrial-based positioning signals, such as one or more radio frequency (RF) modalities (e.g., WiFi®-Received Signal Strength Indication (RSSI) Round Trip Time (RTT), and Bluetooth®-low energy (BLE)). The mobile device may be equipped with sensors, such as an inertial measurement unit (IMU), which provide measurement (e.g., relative turn angle (RTA), heading, step count, etc.), from which movements of the mobile device may be tracked.

### SUMMARY

An example method for determining a position of a user equipment (UE) in an indoor environment using a positioning filter, includes: determining a plurality of predicted positions for the UE in the indoor environment; for at least one given predicted position of the plurality of predicted positions, determining one or more intermediate propagation positions between a previous position corresponding to the given predicted position and the given predicted position, where the one or more intermediate propagation positions represent a straight-line trajectory between the previous position corresponding to the given predicted position and the given predicted position; determining one or more cells of a position estimation exclusion mask that correspond to the one or more intermediate propagation positions and the given predicted position, where each cell of the position estimation exclusion mask corresponds to an area in the indoor environment, where each cell of the position estimation exclusion mask includes a first indication based on the area including one or more obstacles of a plurality of obstacles in the indoor environment or a second indication based on the area not including an obstacle; removing the given predicted position from the plurality of predicted positions based on at least one of the one or more cells including the first indication; and determining the position of the UE in the indoor environment based on the remaining predicted positions in the plurality of predicted positions.

An example UE for determining a position of the UE in an indoor environment using a positioning filter, includes: one or more memories; and one or more processors communicatively coupled to the one or more memories, the one or more processors being configured to: determine a plurality of predicted positions for the UE in the indoor environment; for at least one given predicted position of the plurality of predicted positions, determine one or more intermediate propagation positions between a previous position corresponding to the given predicted position and the given predicted position, wherein the one or more intermediate positions represent a straight-line trajectory between the previous position corresponding to the given predicted position and the given predicted position; determine one or more cells of a position estimation exclusion mask that correspond to the one or more intermediate propagation positions and the given predicted position, where each cell of the position estimation exclusion mask corresponds to an area in the indoor environment, where each cell of the position estimation exclusion mask includes a first indication based on the area including one or more obstacles of a plurality of obstacles in the indoor environment or a second indication based on the area not including an obstacle; remove the given predicted position from the plurality of predicted positions based on at least one of the one or more cells including the first indication; and determine the position of the UE in the indoor environment based on the remaining predicted positions in the plurality of predicted positions.

An example UE for determining a position of the UE in an indoor environment using a positioning filter, includes: means for determining a plurality of predicted positions for the UE in the indoor environment; means for, for at least one given predicted position of the plurality of predicted positions, determining one or more intermediate propagation positions between a previous position corresponding to the given predicted position and the given predicted position, wherein the one or more intermediate positions represent a straight-line trajectory between the previous position corresponding to the given predicted position and the given predicted position; means for determining one or more cells of a position estimation exclusion mask that correspond to the one or more intermediate propagation positions and the given predicted position, where each cell of the position estimation exclusion mask corresponds to an area in the environment, where each cell of the position estimation exclusion mask includes a first indication based on the area including one or more obstacles of a plurality of obstacles in the indoor environment or a second indication based on the area not including an obstacle; means for removing the given predicted position from the plurality of predicted positions based on at least one of the one or more cells including the first indication; and means for determining the position of the UE in the indoor environment based on the remaining predicted positions in the plurality of predicted positions.

An example non-transitory, processor-readable storage medium includes processor-readable instructions for determining a position of a user equipment (UE) in an indoor environment using a positioning filter, the processor-readable instructions to cause one or more processors to: determine a plurality of predicted positions for the UE in the indoor environment; for at least one given predicted position of the plurality of predicted positions, determine one or more intermediate propagation positions between a previous position corresponding to the given predicted position and the given predicted position; determine one or more cells of a position estimation exclusion mask that correspond to the one or more intermediate propagation positions and the given predicted position, where each cell of the position estimation exclusion mask corresponds to an area in the indoor environment, where each cell of the position estimation exclusion mask includes a first indication based on the area including one or more obstacles of a plurality of obstacles in the indoor environment or a second indication based on the area not including an obstacle; remove the given predicted position from the plurality of predicted positions based on at least one of the one or more cells including the first indication; and determine the position of the UE in the indoor environment based on the remaining predicted positions in the plurality of predicted positions.

### BRIEF DESCRIPTION OF THE DRAWINGS

FIG. 1 illustrates an example floorplan for an indoor environment.

FIG. 2 illustrates an example user equipment (UE).

FIG. 3 illustrates an example of the user equipment of FIG. 2.

FIG. 4A illustrates a position estimation exclusion mask for the indoor environment of FIG. 1, with the exclusion mask overlaid on the floorplan for the indoor environment.

FIG. 4B illustrates the example position estimation exclusion mask in FIG. 4A without an overlay on an indoor environment.

FIG. 5 illustrates the example position estimation exclusion mask in FIG. 4B with example intermediate propagation positions.

FIG. 6 illustrates a method for determining a position of a UE in an indoor environment using a positioning filter.

FIG. 7 illustrates a method for determining a position of a UE in the indoor environment using a positioning particle filter.

FIG. 8 further illustrates the method for determining a position of a UE in the indoor environment using a positioning particle filter.

### DETAILED DESCRIPTION

Techniques are discussed herein for performing a positioning operation indoors to estimate a location of a user equipment (UE). An indoor environment may be represented by a position estimation exclusion mask that includes a plurality of cells. Each cell corresponds to an area in the environment. Each cell includes either a first indication based on the area including one or more obstacles or a second indication based on the area not including an obstacle. In applying a positioning filter to determine the position of the UE in the indoor environment, such as positioning particle filter, a plurality of particles may be determined, where each particle represents a potential position of the UE. One or more intermediate propagation positions between a start position and a predicted end position for each particle may be determined. The one or more intermediate propagation positions represent a straight-line trajectory of the particle between the start position and the predicted end position. One or more cells of the position estimation exclusion mask may be identified as corresponding to the one or more intermediate propagation positions and the predicted end position. For example, the coordinates of the one or more intermediate propagation positions and the predicted end position may be matched to coordinates of one or more cells of the position estimation exclusion mask. If any of the matching cells includes the first indication, i.e., indicating that any of the areas corresponding to the matching cells include an obstacle, then the particle is removed from the plurality of particles. The position of the UE in the indoor environment may be determined based on the remaining particles.

Particular aspects of the subject matter described in this disclosure can be implemented to realize one or more of the following potential advantages. Examining the indications in the matching cells of the position estimation exclusion mask to determine whether a particle collides with an obstacle may be less computationally intensive than other approaches, such as by examining whether the trajectory of the particle crosses any segment of a polygon. This in turn reduces the processing capacity and battery capacity required to determine the position of the UE. The position estimation exclusion mask may also reduce the size of the assistance data necessary for positioning, compared with the sending of the obstacles as polygons. Items and/or techniques described herein may provide one or more of the following capabilities, and possibly one or more other capabilities not mentioned. Other capabilities may be provided and not every implementation according to the disclosure must provide any, let alone all, of the capabilities discussed.

Navigational or other location-based services may rely at least partially on determining at least an estimated position of a user equipment (UE). Positioning strategies that are effective in outdoor environments, which may utilize satellite positioning system (SPS) signals or satellite imagery, may be inadequate for indoor environments. Performing a positioning operation indoors to estimate a location of a UE may involve different techniques or strategies as compared to those that may be used outdoors. Within indoor environments, UEs may attempt to effectuate indoor positioning at least partly by processing signals transmitted from transmitters (e.g., wireless transmitter devices) that are located, for example, within an indoor environment at known locations. Examples of transmitters may include wireless transmitter devices that comport with a Wi-Fi access point protocol (e.g., IEEE 802.11), a Bluetooth protocol, a femtocell protocol, or any combination thereof.

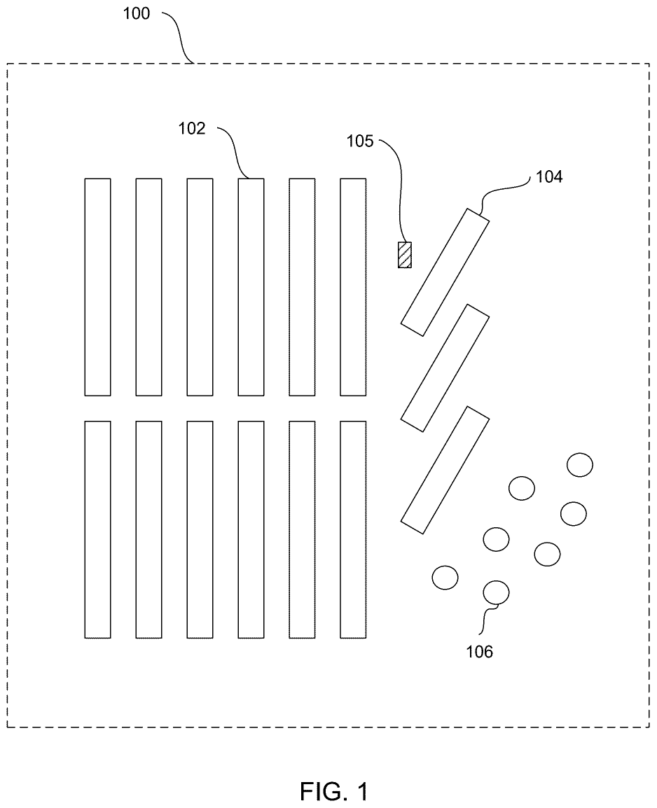

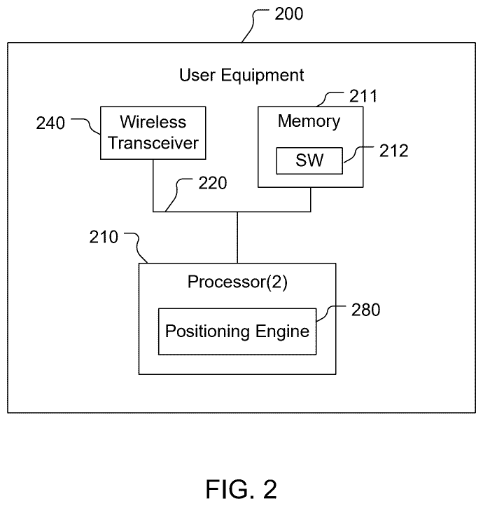

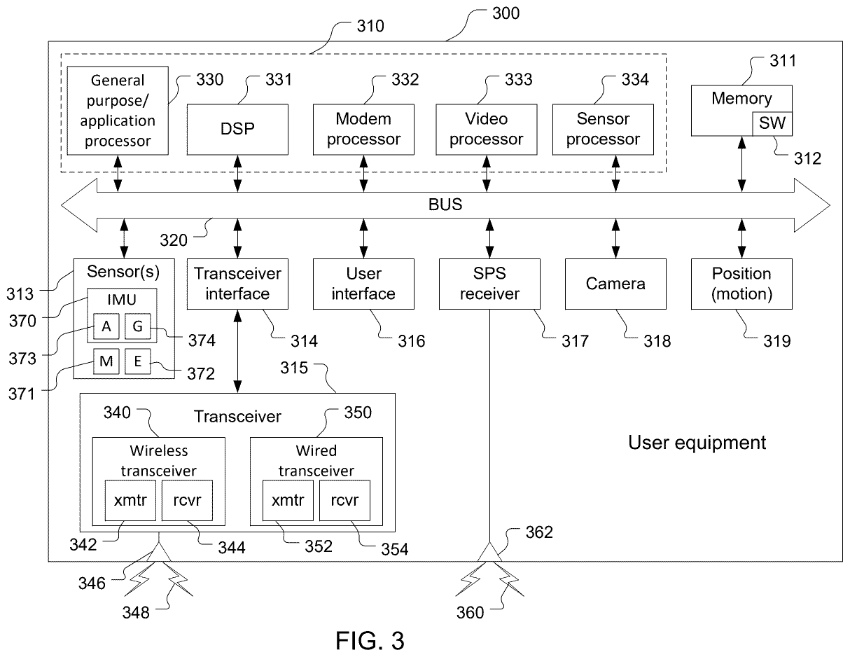

FIG. 1 illustrates an example floorplan for an indoor environment. The indoor environment 100 may include various obstacles that form areas with structured spaces, such as aisles and walkways formed by shelves 102, and areas that are more open or have less structure, such as that formed by a mixture of shelves 104 and displays 106. A user carrying a UE 105 may travel within the indoor environment 100. To provide to a user of the UE 105 a location-based service via a navigational application, an estimated position of the UE 105 within the indoor environment 100 may be determined by a positioning engine of the UE 105. The UE 105 is described further below with reference to FIGS. 2 and 3.

In general, the UE 105 may be any wireless communication device (e.g., a mobile phone, router, tablet computer, laptop computer, consumer asset tracking device, Internet of Things (IoT) device, etc.). A UE 105 may be mobile or may (e.g., at certain times) be stationary. As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. The UE 105 may be embodied by any of a number of types of devices including but not limited to printed circuit (PC) cards, compact flash devices, external or internal modems, wireless or wireline phones, smartphones, tablets, consumer asset tracking devices, asset tags, and so on. The UE 105 may comprise and/or may be referred to as a device, a mobile device, a wireless device, or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, virtual reality headsets, augmented reality glasses, or some other portable or moveable device. The UE 105 supports wireless communication with the target object 102 using one or more Radio Access Technologies (RATs) such as IEEE 802.11 WiFi® (also referred to as Wi-Fi®), Bluetooth® (BT), Ultra-wideband (UWB), etc., that may be used by wireless ranging techniques.

The position of the UE 105 may be referred to as a position estimate, or position fix, and may be geographic, e.g., location coordinates for the UE 105 in three-dimensional space. A position of the UE 105 may be expressed as an area or volume within which the UE 105 is expected to be located with some probability or confidence level (e.g., 67%, 95%, etc.). A position of the UE 105 may be expressed as a relative position comprising, for example, a distance and direction from a reference position. The relative position may be expressed as relative coordinates (e.g., ΔX, ΔY, and ΔZ coordinates) defined relative to the reference position. In the description contained herein, the use of the term “position” may comprise any of these variants unless indicated otherwise.

As a user travels within an indoor environment while carrying the UE 105, position estimates of the UE 105 may be at least partially determined using, for example, one or more signals transmitted from at least one transmitter. A UE 105 may measure characteristics of signals received from one or more transmitters. Such characteristics may include received signal strength indicator or indication (RSSI) measurements, round trip time (RTT) measurements, round trip delay (RTD) measurements, time of arrival (TOA) measurements, angle of arrival (AOA) measurements, or combinations thereof. Using measurements of received wireless signals along with techniques that are known in the art (e.g., trilateration), a location of the UE 105 may be estimated. With trilateration, for example, the UE 105 use well known techniques to obtain a position fix from ranges to multiple transmitters that are positioned at known locations. Ranges to transmitters may be measured based, at least in part, on received wireless signal characteristics (e.g., RSSI, RTT, RTD, TOA, AOA, etc.).

Indirect mechanisms that may be used to determine an estimated location may comprise indirect measurements, predictive procedures, mobility models, or any combinations thereof. For example, a movement model may indicate a possible or likely movement pattern of the UE 105. Implementation of a movement model may include application of positional filtering, consideration of a likely speed of perambulation (e.g., a reasonable or maximum walking speed), or applying a smoothing procedure to a traveled path, etc., just to name a few examples. Other indirect mechanisms may indicate, for example, relative positional movement of a mobile device. Relative positional movement may be determined using one or more indirect measurements. Indirect measurements may be obtained from, by way of example only, one or more inertial sensors such as accelerometer(s), pedometer(s), compass(es), gyroscope(s), or any combination thereof. Additionally or alternatively, determination of a relative positional movement may use, by way of example only, at least one mobility model that considers average or maximum velocity of a pedestrian, a previous location, a previous velocity (e.g., a previous speed or a previous direction of travel, etc.), one or more probabilistic mechanisms, a path smoothing procedure, a path filtering procedure, or any combination thereof.

FIG. 2 illustrates an example user equipment 200. The UE 200 may be an example of UE 105. The UE 200 may comprise one or more processors 210, one or more memories 211 including software (SW) 212, and one or more wireless transceivers 240, although any of these devices may be referred to in the singular (e.g., the processor 210) while including one or more of the respective devices. The one or more processors 210 and the one or more memories 211 may be communicatively coupled to each other by a bus 220 (which may be configured, e.g., for optical and/or electrical communication). The transceiver 240 is configured for wireless communication using one or more RATs. The description herein may refer to the one or more processors 210 performing a function, but this includes other implementations such as where the one or more processors 210 executes software 212 (stored in the one or more memories 211) and/or firmware. The description herein may refer to the UE 200 performing a function as shorthand for one or more appropriate components (e.g., the one or more processors 210 and the one or more memories 211) of the UE 200 performing the function. The one or more processors 210 (possibly in conjunction with the one or more memories 211) may include a positioning engine 280. The positioning engine 280 may be configured to perform positioning operations (e.g., determine position information (e.g., measurements, pseudoranges, position estimates, etc.). The positioning engine 280 is discussed further below, and the description may refer to the one or more processors 210 generally, or the UE 200 generally, as performing any of the functions of the positioning engine 280, with the UE 200 being configured to perform the function(s).

FIG. 3 illustrates an example UE 300. The UE 300 may be an example of the UE 200 shown in FIG. 2. The UE 300 may comprise a computing platform including one or more processors 310, one or more memories 311 including software (SW) 312, one or more sensors 313, a transceiver interface 314 for the transceiver 315 that includes the wireless transceiver 340, a user interface 316, a camera 318, and a position device (PD) 319. The one or more processors 310, the one or more memories 311, the one or more sensors 313, the transceiver interface 314, the user interface 316, the camera 318, and the position device 319 may be communicatively coupled to each other by a bus 320 (which may be configured, e.g., for optical and/or electrical communication). The one or more processors 210 may include one or more intelligent hardware devices, e.g., a central processing unit (CPU), one or more microcontrollers, an application specific integrated circuit (ASIC), etc. The one or more processors 310 may comprise multiple processors including one or more general-purpose/application processors 330, one or more Digital Signal Processors (DSP) 331, one or more modem processors 332, one or more video processors 333, and/or one or more sensor processors 334. For example, the sensor processor 334 may comprise, e.g., processors for RF (radio frequency) sensing (with one or more wireless signals transmitted and reflection(s) used to identify, map, and/or track an object), and/or ultrasound, etc. The one or more modem processors 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 280 for connectivity. The one or more memories 311 may be one or more non-transitory storage media that may include random access memory (RAM), flash memory, disc memory, and/or read-only memory (ROM), etc. The one or more memories 311 may store the software 312 which may be processor-readable, processor-executable software code containing instructions that may be configured to, when executed, cause the one or more processors 310 to perform various functions described herein. Alternatively, the software 312 may not be directly executable by the one or more processors 310 but may be configured to cause the one or more processors 310, e.g., when compiled and executed, to perform the functions. The description herein may refer to the one or more processors 310 performing a function, but this includes other implementations such as where the one or more processors 310 executes software and/or firmware. The description herein may refer to the one or more processors 210 performing a function as shorthand for one or more of the processors 330-334 performing the function. The description herein may refer to the UE 300 performing a function as shorthand for one or more appropriate components of the UE 300 performing the function. Functionality of the one or more processors 310 is discussed more fully below.

The configuration of the UE 300 shown in FIG. 3 is an example and not limiting of the disclosure, including the claims, and other configurations may be used. For example, an example configuration of the UE 300 includes one or more of the processors 330-334 of the one or more processors 310, the one or more memories 311, a wireless transceiver, and one or more of the sensor(s) 313, the user interface 316, the camera 318, and/or the PD 319.

The UE 300 may comprise the modem processor 332 that may be capable of performing baseband processing of signals received and down-converted by the transceiver 315. The modem processor 332 may perform baseband processing of signals to be upconverted for transmission by the transceiver 315. Also, or alternatively, baseband processing may be performed by the general-purpose/application processor 330 and/or the DSP 331. Other configurations, however, may be used to perform baseband processing.

The UE 300 may include the sensor(s) 313 that may include, for example, an Inertial Measurement Unit (IMU) 370, one or more magnetometers 371, and/or one or more environment sensors 372. The IMU 370 may comprise, for example, one or more accelerometers 373 (e.g., collectively responding to acceleration of the UE 280 in three dimensions) and/or one or more gyroscopes 374 (e.g., three-dimensional gyroscope(s)). The sensor(s) 313 may include the one or more magnetometers 371 (e.g., three-dimensional magnetometer(s)) to determine orientation (e.g., relative to magnetic north and/or true north) that may be used for any of a variety of purposes, e.g., to support one or more compass applications. The environment sensor(s) 372 may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the one or more memories 311 and processed by the DSP 331 and/or the general-purpose/application processor 330 in support of one or more applications such as, for example, applications directed to positioning and/or navigation operations. The sensor(s) 313 may comprise one or more of other various types of sensors such as one or more optical sensors, one or more weight sensors, and/or one or more radio frequency (RF) sensors, etc.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The sensor(s) 313 may be useful to determine whether the UE 300 is fixed (stationary) or mobile. For example, for relative positioning information, the sensors/IMU may be used to determine the angle and/or orientation of the other device with respect to the UE 300, etc.

The IMU 370 may be configured to provide measurements about a direction of motion and/or a speed of motion of the UE 300, which may be used in relative location determination. For example, the one or more accelerometers 373 and/or the one or more gyroscopes 374 of the IMU 370 may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference position of the UE 300 may be determined for a moment in time and measurements from the accelerometer(s) 373 and the gyroscope(s) 374 taken after this moment in time may be used (e.g., in dead reckoning) to determine present position of the UE 300 based on movement (direction and distance) of the UE 300 relative to the reference location.

The magnetometer(s) 371 may determine magnetic field strengths in different directions which may be used to determine orientation of the UE 300. For example, the orientation may be used to provide a digital compass for the UE 300. The magnetometer(s) may include a two-dimensional magnetometer configured to detect and provide indications of magnetic field strength in two orthogonal dimensions. The magnetometer(s) 371 may include a three-dimensional magnetometer configured to detect and provide indications of magnetic field strength in three orthogonal dimensions. The magnetometer(s) 371 may provide means for sensing a magnetic field and providing indications of the magnetic field, e.g., to the one or more processors 310.

The transceiver 315 may include a wireless transceiver 340 configured to communicate with other devices through wireless connections. For example, the wireless transceiver 340 may include a wireless transmitter 342 and a wireless receiver 344 coupled to an antenna 346 for transmitting and/or receiving wireless signals 348 and transducing signals from the wireless signals 348 to wired (e.g., electrical and/or optical) signals and from wired (e.g., electrical and/or optical) signals to the wireless signals 348. The wireless receiver 344 includes appropriate components (e.g., one or more amplifiers, one or more frequency filters, and an analog-to-digital converter). The wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals according to a variety of radio access technologies (RATs) such as IEEE 802.11 (including IEEE 802.11az), WiFi®, WiFi® Direct (WiFi®-D), Bluetooth®, Ultra-Wide Band (UWB) (including 802.15.4), etc. A “radio”, as used herein, refers to a wireless transmitter and/or wireless receiver configured to communicate signals according to a specific RAT. The transceiver 215 may be communicatively coupled to the transceiver interface 314, e.g., by optical and/or electrical connection. The transceiver interface 314 may be at least partially integrated with the transceiver 315. The wireless transmitter 342, the wireless receiver 344, and/or the antenna 346 may include multiple transmitters, multiple receivers, and/or multiple antennas, respectively, for sending and/or receiving, respectively, appropriate signals.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the one or more memories 311 to be processed by DSP 331 and/or the general-purpose/application processor 330 in response to action from a user or a request from an application. Similarly, applications hosted on the UE 300 may store indications of analog and/or digital signals in the one or more memories 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also, or alternatively, the user interface 316 may comprise one or more touch sensors responsive to touching and/or pressure, e.g., on a keyboard and/or touch screen of the user interface 316.

The UE 300 may include the camera 318 for capturing still or moving imagery. The camera 318 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 330 and/or the DSP 331. Also, or alternatively, the video processor 333 may perform conditioning, encoding, compression, and/or manipulation of signals representing captured images. The video processor 333 may decode/decompress stored image data for presentation on a display device (not shown), e.g., of the user interface 316.

The position device (PD) 319 may be configured to determine a position of the UE 300, motion of the UE 300, and/or relative position of the UE 300, and/or time. The PD 319 may work in conjunction with the one or more processors 310 and the one or more memories 311 as appropriate to perform at least a portion of one or more positioning methods, although the description herein may refer to the PD 319 being configured to perform, or performing, in accordance with the positioning method(s). The PD 319 may also or alternatively be configured to determine location of the UE 300 using terrestrial-based signals (e.g., at least some of the wireless signals 348) for trilateration. The PD 319 may be configured to use one or more images from the camera 318 and image recognition combined with known locations of landmarks (e.g., natural landmarks such as mountains and/or artificial landmarks such as buildings, bridges, streets, etc.) to determine location of the UE 300. The PD 319 may be configured to determine a relative motion or orientation by the UE 300 by comparing multiple images captured by the camera 318 and tracking how a common “point of interest” within the images moves between images. The PD 319 may be configured to use one or more other techniques (e.g., relying on the UE's self-reported location (e.g., part of the UE's position beacon)) for determining the location of the UE 300, and may use a combination of techniques (e.g., satellite and terrestrial positioning signals) to determine the location of the UE 300. The PD 319 may include one or more of the sensors 313 (e.g., gyroscope(s), accelerometer(s), magnetometer(s), etc.) that may sense orientation and/or motion of the UE 300 and provide indications thereof that the one or more processors 310 (e.g., the general-purpose/application processor 330 and/or the DSP 331) may be configured to use to determine motion (e.g., a velocity vector and/or an acceleration vector) of the UE 300. The PD 319 may be configured to provide indications of uncertainty and/or error in the determined position and/or motion. Functionality of the PD 319 may be provided in a variety of manners and/or configurations, e.g., by the general-purpose/application processor 330, the transceiver 315, and/or another component of the UE 300, and may be provided by hardware, software, firmware, or various combinations thereof.

Positioning particle filters may be used for indoor navigation and positioning of a UE to create a probabilistic positioning model. With a positioning particle filter, a UE's location(s) or estimated locations may be represented by multiple particles. Each particle may represent a possible state or potential position of a UE 105. A combination of multiple particles (e.g., an average, a centroid, a mean, etc. with an error or confidence range that is derived from a combination of multiple particles) of a particle cloud may be considered at least one estimated position of a UE 105. Additionally or alternatively, one or more individual particles of multiple particles of a particle cloud may be considered at least one estimated position of a UE 105. In response to movement of the UE 105, particles may be propagated according to a probability distribution. Particles may be propagated in accordance with a probability distribution further along a corridor, around a corner, by branching at an intersection, by taking a portal (e.g., a stairway, an escalator, an elevator, etc.) to a different floor, or any combination thereof.

In some positioning particle filters, the perimeter of obstacles in the indoor environment may be represented by polygons. In determining whether a particle collides with an obstacle, the positioning particle filter may determine whether the trajectory of the propagated particle crosses any segment of any polygon. Any particle that collides with an obstacle may be removed from the particle cloud. The remaining particles may be weighted or reweighed, and the position of the UE may be determined based on the remaining particles in the particle cloud. With numerous particles in the particle cloud, and with numerous iterations of the positioning particle filter, the collision determination using polygons to represent obstacles may be computationally intensive. To perform the positioning on the UE 105, the UE 105 may be required to include a graphics processor of sufficient processing capacity and/or a battery with sufficient storage capacity to support the computations.

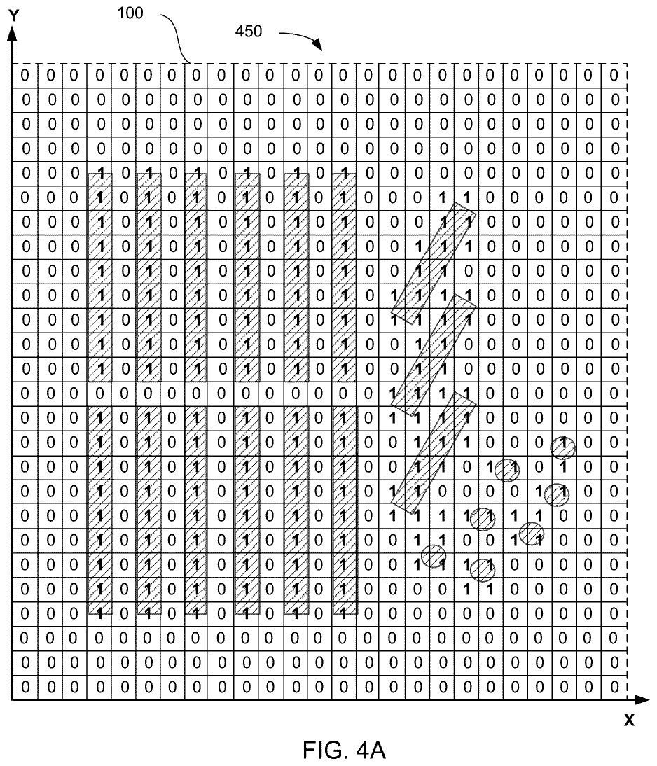

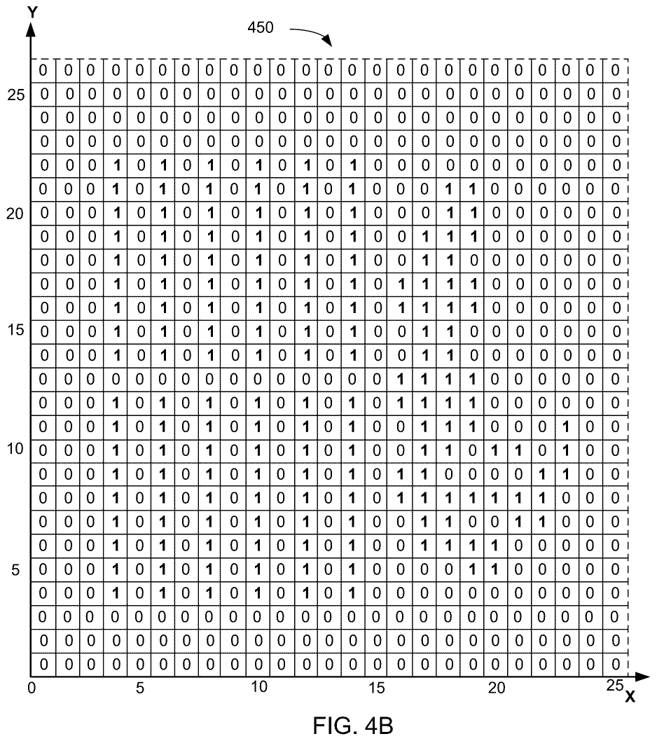

In an embodiment, the processing capacity and/or battery capacity may be reduced through the use of a position estimation exclusion mask, instead of polygons, during particle propagation. An indoor environment may be represented by a position estimation exclusion mask overlaid on the floorplan for the indoor environment containing a plurality of static obstacles. In an example implementation, the position estimation exclusion mask may be predetermined, i.e., determined independently of a position estimation by the positioning engine 280. FIG. 4A illustrates an example exclusion mask 450 for the indoor environment 100 of FIG. 1, with the exclusion map 450 overlaid on the floorplan for the indoor environment 100. FIG. 4B illustrates the position estimation exclusion map 450 without the overlay on the floorplan for the indoor environment 100. The position estimation exclusion map 450 may include a plurality of cells or bins, each corresponding to an area in the environment 100. The plurality of cells may be a regular arrangement of cells of any shape, such as the rectangular shape shown in FIGS. 4A and 4B. The resolution of the cells may be configurable (e.g., 10 cm×10 cm cells) and may be based on a minimum size or depth of the obstacles in the environment. Each cell may be assigned a unique identifier which corresponds to their coordinate in the position estimation exclusion map 450. Each cell may include an indication of whether its corresponding area contains at least a portion of an obstacle, i.e., whether the area is navigable. If an area is not navigable, i.e., the area includes at least a portion of an obstacle, then the corresponding cell may be configured to include a first indication. If the area is navigable, i.e., the area does not include any obstacles, then the corresponding cell may be configured to include a second indication. For example, the indications may be binary, where the first indication is a ‘1’ and the second indication is a ‘0’. For example, as illustrated in FIG. 4A, the cells that correspond to areas that include at least a portion of a shelf 102, 104 or a display 106 includes a ‘1’, indicating that these areas are not navigable. The cells that correspond to areas without obstacles include a ‘0’, indicating that these areas are navigable. The position estimation exclusion map 450 may be provided to the positioning engine 280 of the UE 105, such as by being included in the positioning assistance data provided by a network server.

For example, in the initialization of the positioning particle filter, a plurality of particles in the particle cloud may be placed proximate to an initial position of the UE 105. In response to movement of the UE 105, the positioning particle filter may propagate each particle in a particle cloud to a new state or new predicted position according to a probability distribution, where each particle may be associated with a start position and a predicted end position. One or more intermediate propagation positions between the start position and the predicted end position may be determined for each particle, where the one or more intermediate propagation positions represent a straight-line trajectory of the propagated particle from the start position to the predicted end position. The one or more intermediate propagation positions may be expressed as:

$${P}_{n} = \frac{n \cdot {P}_{E} + ( p - n ) \cdot {P}_{S}}{p} ,$$

for n=1 to └p┘ and

$$p = \frac{{P}_{E} - {P}_{S}}{c} , \qquad ( Eq . 1 )$$

where P_{S} is the start position for the particle,
P_{E} is the predicted end position for the particle,
n is the index for an intermediate propagation position,
Pₙ is the intermediate propagation position with index n,
c is the cell spacing in the position estimation exclusion map, and
p is the interval or length of the steps between intermediate propagation positions.
   The size of the interval p between the intermediate propagation positions may be configured to be the same as or less than the cell spacing c in the exclusion mask 450, to prevent a trajectory that may result in the “jumping over” of a cell that indicates an obstacle.

The position estimation exclusion mask 450 may be used by the positioning particle filter during one or more iterations of the propagation of the particles in the particle cloud. For each particle, one or more cells in the position estimation exclusion mask 450 that correspond to each of the one or more intermediate propagation positions and the predicted end position may be determined. For example, the coordinates of the one or more intermediate propagation positions and the predicted end position may be matched to the coordinates of one or more cells in the position estimation exclusion map. Referring to FIGS. 4A and 4B, the axes for the coordinates of the one or more intermediate propagation positions and the predicted end positions may be aligned with the axes of the exclusion map 450. In an example implementation, the matching of the coordinates for the one or more intermediate propagation positions Pₙ and the coordinates for the predicated end position P_{E} to coordinates of the one or more cells in the position estimation exclusion map 450 may be expressed as:

$$For {P}_{n} = ( {x}_{n} , {y}_{n} ) , cell coordinate = ( {x}_{n} \cdot c , {y}_{n} \cdot c ) for n = 1 to ⌊ p ⌋ \qquad ( Eq . 2 )$$

$$For {P}_{E} = ( {x}_{E} , {y}_{E} ) , cell coordinate = ( {x}_{E} \cdot c , {y}_{E} \cdot c ) \qquad ( Eq . 3 )$$

The indication included in the corresponding one or more cells may be examined to determine whether any of the cells include the indication of an obstacle. The trajectory of the propagated particle may be determined to collide with an obstacle based on any of the cells including the indication of an obstacle, and the particle may be removed from the particle cloud.

Determining whether a trajectory of a propagated particle collides with an obstacle using the indications in the cells of the position estimation exclusion mask 450 may be less computationally intensive than determining whether the trajectory of the particle crosses any segment of a polygon. This in turn reduces the processing capacity and battery capacity required to propagate the particles in the particle cloud. The reduction in the required processing and battery capacity may allow the positioning estimation to be practically performed by the UE 105 instead of a network server. The position estimation exclusion mask may also reduce the size of the assistance data necessary for positioning, compared with the sending of the obstacles as polygons. The speed at which the particles are propagated may be independent of the density of obstacles in the environment or the size of the position estimation exclusion mask 450.

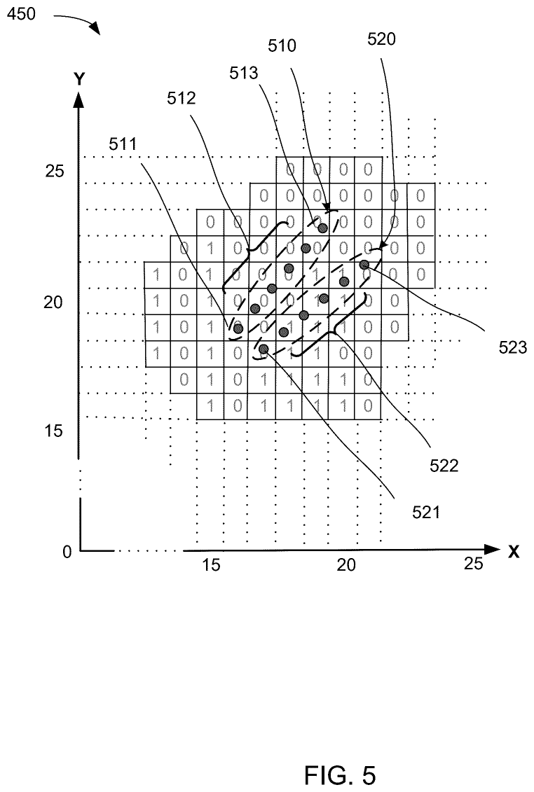

Referring to FIG. 5, in a first example, a first particle with a first start position 511 may be propagated to a first predicted end position 513. One or more first intermediate propagation positions 512 between the first start position 511 and the first predicted end position 513 may be determined, representing a first straight-line trajectory 510 in the propagation of the first particle. One or more cells in the position estimation exclusion map 450 may be determined that correspond to each of the first intermediate positions 512 and the first predicted end position 513. For example, the first intermediate positions 512 and the first predicted end position 513 may correspond to a first array of cells at the coordinates: {(17, 20), (17, 21), (18, 21), (18, 22), (19, 23), (19, 22)}. The indications for each cell in the first array may be examined to determine whether the propagation of the first particle collides with an obstacle. For the first array of cells, each cell includes the second indication, e.g., a ‘0’, which indicates that the propagation of the first particle does not collide with any obstacles in the environment, and the first particle remains in the particle cloud.

Referring again to FIG. 5, in a second example, a second particle with a second start position 521 may be propagated to a second predicted end position 523. One or more second intermediate propagation positions 522 between the second start position 521 and the second predicted end position 523 may be determined, representing a second straight-line trajectory 520 in the propagation of the second particle. One or more cells in the position estimation exclusion map 450 may be identified that correspond to each of the second intermediate propagation positions 522 and the second predicted end position 523. For example, the second intermediate propagation positions 522 and the second predicted end position 523 may correspond to a second array of cells at the coordinates: {(18, 19), (18, 20), (19, 19), (19, 20), (20, 21), (21, 21), (21, 22)}. The indications for each cell in the second array may be examined to determine whether the propagation of the second particle collides with an obstacle. For the second array of cells, the cells corresponding to coordinates (18, 19), (19, 19), (19, 20), and (20, 21) each include the first indication, e.g., a ‘1’. The first indication in any of these cells indicates that the propagation of the second particle collides with an obstacle in the environment, and the second particle may be removed from the particle cloud.

For the remaining particles in the particle cloud, the weight of one or more of the particles may be updated based on the predicted end position of the particle and one or more sensor measurements from the UE 105. For example, referring to FIG. 3, the one or more sensor measurements may include measurements of one or more RATs, such as signal strength or range measurements from the transceiver 315. The one or more sensor measurement may also include measurements from the one or more sensors 313. The one or more sensor measurements may provide a speed and heading for each particle in the particle cloud. For example, the weights of each particle in the particle cloud may be modified based on the consistency between the propagated or predicted state of the particle and the one or more sensor measurements. The less consistent the predicted state is compared to the one or more sensor measurements, the more the particle's weight is reduced. The modified weight of each particle may be compared with a threshold, and the particle may be removed from the particle cloud based on the modified weight being below the threshold. The threshold may represent the probability below which the position of the particle is considered unlikely to be the true position of the UE 105. For example, the threshold may be expressed as an absolute value, a proportion of a sum of the particles in the particle cloud, or a proportion of the greatest weight in the particle cloud (i.e., a proportion of the weight of the heaviest particle in the particle cloud). The position of the UE 105 may be determined based on the remaining particles in the particle cloud after removing the particles with weight that fall below the threshold. For example, the particle in the remaining particles with the greatest weight may be used to determine the estimated position of the UE 105. Other techniques may be used to determine the position of the UE, such as positioning based on the distribution of the remaining particles in the plurality of particles. For example, in the cells that contain the remaining particles, a sum of the weights of the particles in each cell may be determined, and the cell with the largest sum may be used as the position of the UE 105. For another example, a 2D convolution may be performed on the grid cells using an m×m (e.g., 3×3 or 5×5) matrix, where the maximum value from the convolution may be used as the position of the UE 105.

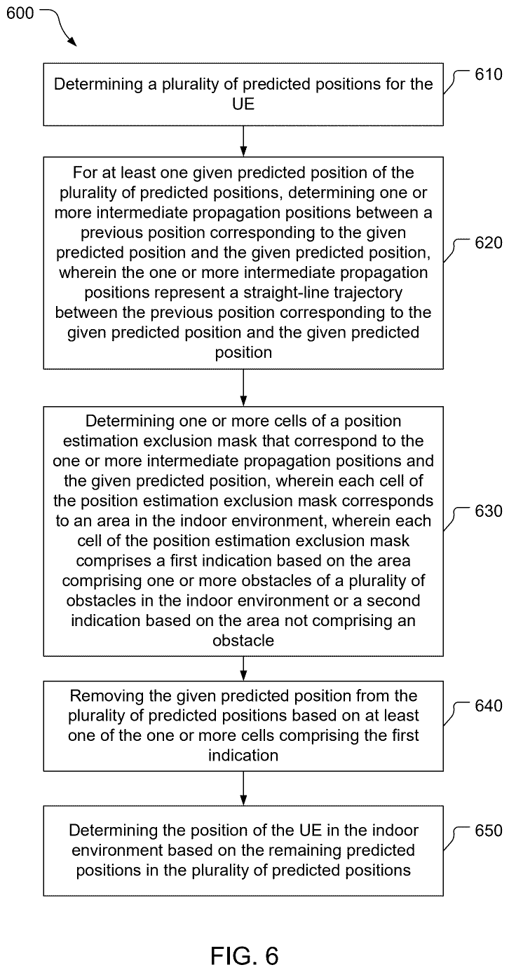

Referring to FIG. 6, with further reference to FIGS. 4A, 4B, and 5, a method 600 for determining a position of a UE in an indoor environment using a positioning filter includes the stages shown. The method 600 is, however, an example only and not limiting. The method 600 may be altered, e.g., by having one or more stages added, removed, rearranged, combined, performed concurrently, and/or by having one or more single stages split into multiple stages.

At stage 610, the method 600 includes determining a plurality of predicted positions for the UE in the indoor environment. For example, in response to movement of the UE 105, the positioning filter may propagate a plurality of potential positions for the UE 105 to the plurality of predicted positions according to a probability distribution. The one or more processors 210, possibly in combination with the one or more memories 211, may comprise means for determining a plurality of predicted positions for the UE.

At stage 620, the method 600 includes, for at least one given predicted position of the plurality of predicted positions, determining one or more intermediate propagation positions between a previous position corresponding to the given predicted position and the given predicted position, wherein the one or more intermediate propagation positions represent a straight-line trajectory between the previous position corresponding to the given predicted position and the given predicted position. For example, the one or more intermediate propagation positions may represent a straight-line trajectory from the previous position to the given predicted position. The one or more processors 210, possibly in combination with the one or more memories 211, may comprise means for, for at least one given predicted position in the plurality of predicted positions, determining one or more intermediate propagation positions between a previous position corresponding to the given predicted position and the given predicted position, wherein the one or more intermediate propagation positions represent a straight-line trajectory between the previous position corresponding to the given predicted position and the given predicted position.

At stage 630, the method 600 includes determining one or more cells of a position estimation exclusion mask that correspond to the one or more intermediate propagation positions and the given predicted position, wherein each cell of the position estimation exclusion mask corresponds to an area in the indoor environment, wherein each cell of the position estimation exclusion mask comprises a first indication based on the area comprising one or more obstacles of a plurality of obstacles in the indoor environment or a second indication based on the area not comprising an obstacle. For example, the environment may include an indoor environment 100 with a floorplan represented by a position estimation exclusion map 450. The position estimation exclusion map 450 may be included in assistance data provided to the UE 105 by a network server. The position estimation exclusion map 450 may include a plurality of cells or bins, each corresponding to an area in the environment 100. Each cell may include an indication of whether its corresponding area contains at least a portion of an obstacle, i.e., whether the area is navigable. If an area is not navigable, i.e., the area includes at least a portion of an obstacle, then the corresponding cell may be configured to include a first indication. If the area is navigable, i.e., the area does not include any obstacles, then the corresponding cell may be configured to include a second indication. For each predicted position, one or more cells in the position estimation exclusion mask 450 that correspond to each of the one or more intermediate propagation positions and the predicted position may be determined. The one or more processors 210, possibly in combination with the one or more memories 211, may comprise means for determining one or more cells of a position estimation exclusion mask that correspond to the one or more intermediate propagation positions and the given predicted position.

At stage 640, the method 600 includes removing the given predicted position from the plurality of predicted positions based on at least one of the one or more cells comprising the first indication. For example, the one or more cells may be examined to determine whether any of the cells include the first indication. The given predicted position may be determined to be associated with a trajectory that collides with an obstacle based on any of the cells including the first indication, and the given predicted position may be removed from the plurality of predicted positions. For example, the given predicted position may be maintained in the plurality of predicted positions based on each of the one or more cells comprising the second indication. The one or more processors 210, possibly in combination with the one or more memories 211, may comprise means for removing the given predicted position from the plurality of predicted positions based on at least one of the one or more cells comprising the first indication.

At stage 650, the method 600 includes determining the position of the UE in the indoor environment based on the remaining predicted positions in the plurality of predicted positions. The one or more processors 210, possibly in combination with the one or more memories 211, may comprise means for determining the position of the UE in the indoor environment based on the remaining predicted positions in the plurality of predicted positions.

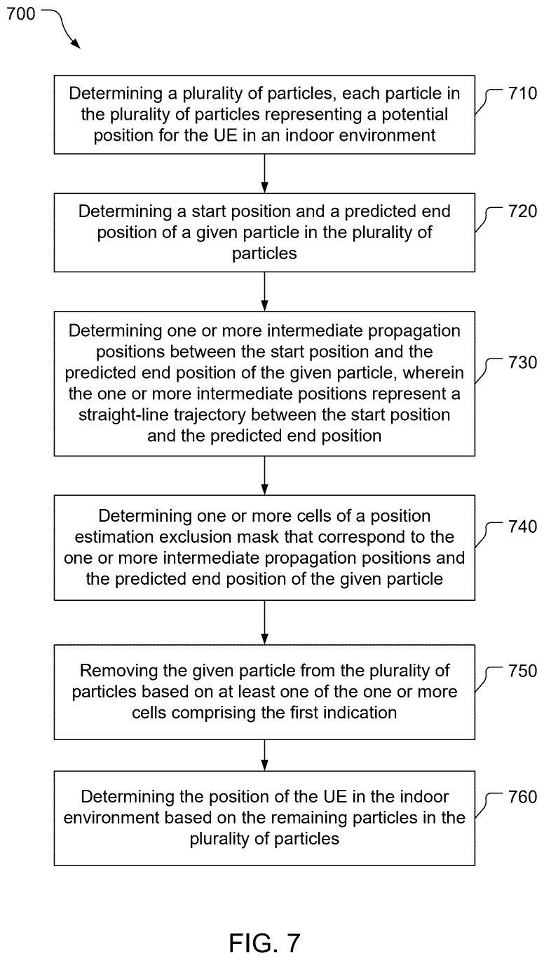

Implementations of the method 600 may include one or more of the following features. In an example implementation, the positioning filter includes a positioning particle filter. Referring to FIG. 7, with further reference to FIGS. 4A, 4B, and 5, a method 700 for determining a position of a UE using a positioning particle filter includes the stages shown. The method 700 is, however, an example only and not limiting. The method 700 may be altered, e.g., by having one or more stages added, removed, rearranged, combined, performed concurrently, and/or by having one or more single stages split into multiple stages.

At stage 710, the method 700 may include determining a plurality of particles, each particle in the plurality of particles representing a potential position for the UE in an indoor environment. For example, the plurality of particles may form a particle cloud. The one or more processors 210, possibly in combination with the one or more memories 211, may comprise means for determining a plurality of particles, each particle in the plurality of particles representing a potential position for the UE in an indoor environment.

At stage 720, the method 700 may include determining a start position and a predicted end position of a given particle in the plurality of particles. For example, in response to movement of the UE 105, the positioning particle filter may propagate each given particle in the particle cloud from the start position to the new predicted end position according to a probability distribution. The one or more processors 210, possibly in combination with the one or more memories 211, may comprise means for determining a start position and a predicted end position of a given particle in the plurality of particles.

At stage 730, the method 700 may include determining one or more intermediate propagation positions between the start position and the predicted end position of the given particle, wherein the one or more intermediate propagation positions represent a straight-line trajectory between the start position and the predicted end position. For example, one or more intermediate propagation positions may represent a straight-line trajectory of the propagated particle from the start position to the predicted end position. In an example implementation, the one or more intermediate propagation positions may be expressed according to Equation 1 above. The one or more processors 210, possibly in combination with the one or more memories 211, may comprise means for determining one or more intermediate propagation positions between the start position and the predicted end position of the given particle.

At stage 740, the method 700 may include determining one or more cells of an position estimation exclusion mask that correspond to the one or more intermediate propagation positions and the predicted end position of the given particle. For example, each cell of the position estimation exclusion mask 450 corresponds to an area in the environment, where each cell of the position estimation exclusion mask comprises a first indication based on the area comprising one or more obstacles or a second indication based on the area not comprising an obstacle. For example, the coordinates of the one or more intermediate propagation positions and the predicted end position may be matched to coordinates of the one or more cells of the position estimation exclusion mask 450. In an example implementation, the determination of the corresponding cells may be expressed according to Equations 2 and 3 above. The one or more processors 210, possibly in combination with the one or more memories 211, may comprise means for determining one or more cells of an position estimation exclusion mask that correspond to the one or more intermediate propagation positions and the predicted end position of the given particle.

At stage 750, the method 700 may include removing the given particle from the plurality of particles based on at least one of the one or more cells comprising the first indication. For example, the indication included in the corresponding one or more cells may be examined to determine whether any of the cells include the first indication. The trajectory of the propagated particle may be determined to collide with an obstacle based on any of the cells including the first indication, and the propagated particle may be removed from the particle cloud. For example, the given particle may be maintained in the plurality of particles based on each of the one or more cells comprising the second indication. The one or more processors 210, possibly in combination with the one or more memories 211, may comprise means for removing the given particle from the plurality of particles based on at least one of the one or more cells comprising the first indication.

At stage 760, the method 700 may include determining the position of the UE in the indoor environment based on the remaining particles in the plurality of particles. The one or more processors 210, possibly in combination with the one or more memories 211, may comprise means for determining the position of the UE based on the remaining particles int eh plurality of particles.

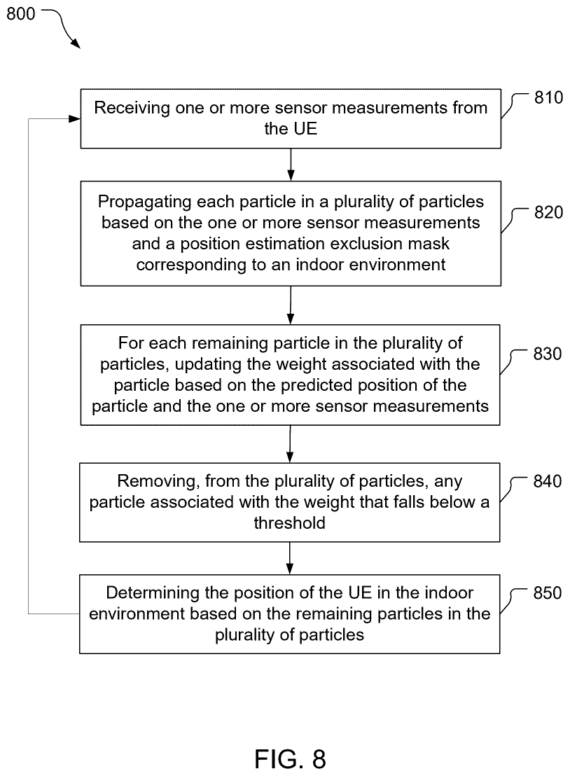

Referring to FIG. 8, with further reference to FIGS. 2 and 3, a method 800 for determining a position of the UE using a position particle filter includes the stages shown. The method 800 is, however, an example only and not limiting. The method 800 may be altered, e.g., by having one or more stages added, removed, rearranged, combined, performed concurrently, and/or by having one or more single stages split into multiple stages.

At stage 810, the method 800 may include receiving one or more sensor measurements from the UE. For example, in the initialization of the positioning particle filter, a plurality of particles in the particle cloud may be placed proximate to an initial position of the UE in an indoor environment. Referring to FIG. 3, the one or more sensor measurements may include measurements of one or more RATs, such as signal strength or range measurements from the transceiver 315. The one or more sensor measurement may also include measurements from the one or more sensors 313. The one or more sensor measurements may provide a speed and heading for each particle in the particle cloud. The one or more processors 210, possibly in combination with the one or more memories 211, may comprise means for receiving one or more sensor measurements from the UE.

At stage 820, the method 800 may include propagating each particle in a plurality of particles based on the one or more sensor measurements and a position estimation exclusion mask corresponding to an indoor environment. For example, the particles in a particle cloud may be propagated according to stages 720 through 750 of the method 700, shown in FIG. 7. The one or more processors 210, possibly in combination with the one or more memories 211, may comprise means for propagating each particle in a plurality of particles based on the one or more sensor measurements and a position estimation exclusion mask corresponding to an indoor environment.

At stage 830, the method 800 may include, for each remaining particle in the plurality of particles, updating the weight associated with the particle based on the predicted position of the particle and the one or more sensor measurements. For example, the weights of each particle in the particle cloud may be modified based on the consistency between the propagated or predicted state of the particle and the one or more sensor measurements. The less consistent the predicted state is compared to the one or more sensor measurements, the more the particle's weight is reduced. The one or more processors 210, possibly in combination with the one or more memories 211, may comprise means for, for each remaining particle in the plurality of particles, updating the weight associated with the particle based on the predicted position of the particle and the one or more sensor measurements.

At stage 840, the method 800 may include removing, from the plurality of particles, any particle associated with the weight that falls below a threshold. The threshold may represent the probability below which the position of the particle is considered unlikely to be the true position of the UE 105. For example, the threshold may be expressed as an absolute value, a proportion of a sum of the particles in the particle cloud, or a proportion of the greatest weight in the particle cloud (i.e., a proportion of the weight of the heaviest particle in the particle cloud). For example, if the modified weight of the particle falls below the threshold, then the particle may be removed from the particle cloud. The one or more processors 210, possibly in combination with the one or more memories 211, may comprise means for removing, from the plurality of particles, any particle associated with the weight that falls below a threshold.

At stage 850, the method 800 may include determining the position of the UE in the indoor environment based on the remaining particles in the plurality of particles. For example, the particle in the remaining particles with the greatest weight may be used to determine the estimated position of the UE 105. Other techniques may be used to determine the position of the UE, such as positioning based on the distribution of the remaining particles in the plurality of particles. For example, in the cells that contain the remaining particles, a sum of the weights of the particles in each cell may be determined, and the cell with the largest sum may be used as the position of the UE 105. For another example, a 2D convolution may be performed on the grid cells using an m×m (e.g., 3×3 or 5×5) matrix, where the maximum value from the convolution may be used as the position of the UE 105. The one or more processors 210, possibly in combination with the one or more memories 211, may comprise means for determining the position of the UE in the indoor environment based on the remaining particles in the plurality of particles.

Stages 810 through 850 may be repeated with further sensor measurements from the UE 105. Optionally, if the number of particles remaining in the particle cloud falls below a certain threshold number required for accurate results, additional particles may be added to the sample and initialized for the next iteration of the method 800.

### Implementation Examples

Implementation examples are provided in the following numbered clauses.

Clause 1. A method for determining a position of a user equipment (UE) in an indoor environment using a positioning filter, comprising: determining a plurality of predicted positions for the UE in the indoor environment; for at least one given predicted position of the plurality of predicted positions, determining one or more intermediate propagation positions between a previous position corresponding to the given predicted position and the given predicted position, wherein the one or more intermediate propagation positions represent a straight-line trajectory between the previous position corresponding to the given predicted position and the given predicted position; determining one or more cells of a position estimation exclusion mask that correspond to the one or more intermediate propagation positions and the given predicted position, wherein each cell of the position estimation exclusion mask corresponds to an area in the indoor environment, wherein each cell of the position estimation exclusion mask comprises a first indication based on the area comprising one or more obstacles of a plurality of obstacles in the indoor environment or a second indication based on the area not comprising an obstacle; removing the given predicted position from the plurality of predicted positions based on at least one of the one or more cells comprising the first indication; and determining the position of the UE in the indoor environment based on remaining predicted positions in the plurality of predicted positions.

Clause 2. The method of clause 1, wherein the positioning filter comprises a positioning particle filter, wherein the determining of the plurality of predicted positions for the UE, comprises: determining a plurality of particles, each particle in the plurality of particles representing a potential position for the UE in the indoor environment; and determining a start position and a predicted end position of each particle in the plurality of particles.

Clause 3. The method of clause 2, wherein the determining of the one or more cells of the position estimation exclusion mask that correspond to the one or more intermediate propagation positions and the given predicted position and the removing of the given predicted position from the plurality of predicted positions, comprise: determining the one or more intermediate propagation positions between the start position and the predicted end position of a given particle of the plurality of particles, wherein the one or more intermediate propagation positions represent the straight-line trajectory between the start position and the predicted end position; determining the one or more cells of the position estimation exclusion mask that correspond to the one or more intermediate propagation positions and the predicted end position of the given particle; and removing the given particle from the plurality of particles based on at least one of the one or more cells comprising the first indication.

Clause 4. The method of clause 3, wherein the determining of the position of the UE based on the remaining predicted positions in the plurality of predicted positions, comprises: determining the position of the UE based on the remaining particles in the plurality of particles.

Clause 5. The method of clause 1, wherein the plurality of obstacles in the indoor environment comprises a plurality of static obstacles.

Clause 6. The method of clause 1, wherein the removing of the given predicted position from the plurality of predicted positions comprises: determining that the straight-line trajectory collides with at least one obstacle in the indoor environment based on the at least one of the one or more cells comprising the first indication.

Clause 7. The method of clause 1, wherein the determining of the one or more cells of the position estimation exclusion mask that correspond to the one or more intermediate propagation positions and the given predicted position, comprises: matching coordinates of the one or more intermediate propagation positions and coordinates of the given predicted position to coordinates of the one or more cells.

Clause 8. The method of clause 1, further comprising: maintaining the given predicted position in the plurality of predicted positions based on each of the one or more cells comprising the second indication.

Clause 9. A user equipment (UE) for determining a position of the UE in an indoor environment using a positioning filter, comprising: one or more memories; and one or more processors communicatively coupled to the one or more memories, the one or more processors being configured to: determine a plurality of predicted positions for the UE in the indoor environment; for at least one given predicted position of the plurality of predicted positions, determine one or more intermediate propagation positions between a previous position corresponding to the given predicted position and the given predicted position, wherein the one or more intermediate positions represent a straight-line trajectory between the previous position corresponding to the given predicted position and the given predicted position; determine one or more cells of a position estimation exclusion mask that correspond to the one or more intermediate propagation positions and the given predicted position, wherein each cell of the position estimation exclusion mask corresponds to an area in the environment, wherein each cell of the position estimation exclusion mask comprises a first indication based on the area comprising one or more obstacles of a plurality of obstacles in the indoor environment or a second indication based on the area not comprising an obstacle; remove the given predicted position from the plurality of predicted positions based on at least one of the one or more cells comprising the first indication; and determine the position of the UE in the indoor environment based on remaining predicted positions in the plurality of predicted positions.

Clause 10. The UE of clause 9, wherein the positioning filter comprises a positioning particle filter, wherein the one or more processors configured to determine the plurality of predicted positions for the UE in the indoor environment are further configured to: determine a plurality of particles, each particle in the plurality of particles representing a potential position for the UE; and determine a start position and a predicted end position of each particle in the plurality of particles.

Clause 11. The UE of clause 10, wherein the one or more processors configured to determine the one or more cells of the position estimation exclusion mask that correspond to the one or more intermediate propagation positions and the given predicted position, and configured to remove the given predicted position from the plurality of predicted positions, are further configured to: determine the one or more intermediate propagation positions between the start position and the predicted end position of a given particle of the plurality of particles, wherein the one or more intermediate propagation positions represent the straight-line trajectory between the start position and the predicted end position; determine the one or more cells of the position estimation exclusion mask that correspond to the one or more intermediate propagation positions and the predicted end position of the given particle; and remove the given particle from the plurality of particles based on at least one of the one or more cells comprising the first indication.

Clause 12. The UE of clause 11, wherein the one or more processors configured to determine the position of the UE based on the remaining predicted positions in the plurality of predicted positions are further configured to: determine the position of the UE based on the remaining particles in the plurality of particles.

Clause 13. The UE of clause 9, wherein the plurality of obstacles in the indoor environment comprises a plurality of static obstacles.

Clause 14. The UE of clause 9, wherein the one or more processors configured to remove the given predicted position from the plurality of predicted positions are further configured to: determine that the straight-line trajectory collides with at least one obstacle in the indoor environment based on the at least one of the one or more cells comprising the first indication.

Clause 15. The UE of clause 9, wherein the one or more processors configured to determine the one or more cells of the position estimation exclusion mask that correspond to the one or more intermediate propagation positions and the given predicted position are further configured to: match coordinates of the one or more intermediate propagation positions and coordinates of the given predicted position to coordinates of the one or more cells.

Clause 16. The UE of clause 9, wherein the one or more processors are further configured to: maintain the given predicted position in the plurality of predicted positions based on each of the one or more cells comprising the second indication.

Clause 17. A user equipment (UE) for determining a position of the UE in an indoor environment using a positioning filter, comprising: means for determining a plurality of predicted positions for the UE in the indoor environment; means for, for at least one given predicted position of the plurality of predicted positions, determining one or more intermediate propagation positions between a previous position corresponding to the given predicted position and the given predicted position, wherein the one or more intermediate positions represent a straight-line trajectory between the previous position corresponding to the given predicted position and the given predicted position; means for determining one or more cells of a position estimation exclusion mask that correspond to the one or more intermediate propagation positions and the given predicted position, wherein each cell of the position estimation exclusion mask corresponds to an area in the indoor environment, wherein each cell of the position estimation exclusion mask comprises a first indication based on the area comprising one or more obstacles of a plurality of obstacles in the indoor environment or a second indication based on the area not comprising an obstacle; means for removing the given predicted position from the plurality of predicted positions based on at least one of the one or more cells comprising the first indication; and means for determining the position of the UE in the indoor environment based on remaining predicted positions in the plurality of predicted positions.

Clause 18. The UE of clause 17, wherein the positioning filter comprises a positioning particle filter, wherein the means for determining the plurality of predicted positions for the UE, comprises: means for determining a plurality of particles, each particle in the plurality of particles representing a potential position for the UE; and means for determining a start position and a predicted end position of each particle in the plurality of particles.

Clause 19. The UE of clause 18, wherein the means for determining the one or more cells of the position estimation exclusion mask that correspond to the one or more intermediate propagation positions and the given predicted position and the means for removing the given predicted position from the plurality of predicted positions, comprise: means for determining the one or more intermediate propagation positions between the start position and the predicted end position of a given particle of the plurality of particles, wherein the one or more intermediate propagation positions represent the straight-line trajectory between the start position and the predicted end position; means for determining the one or more cells of the position estimation exclusion mask that correspond to the one or more intermediate propagation positions and the predicted end position of the given particle; and means for removing the given particle from the plurality of particles based on at least one of the one or more cells comprising the first indication.

Clause 20. The UE of clause 19, wherein the means for determining the position of the UE based on the remaining predicted positions in the plurality of predicted positions, comprises: means for determining the position of the UE based on the remaining particles in the plurality of particles.

Clause 21. The UE of clause 17, wherein the plurality of obstacles in the indoor environment comprises a plurality of static obstacles.

Clause 22. The UE of clause 17, wherein the means for removing the given predicted position from the plurality of predicted positions comprises: means for determining that the straight-line trajectory collides with at least one obstacle in the indoor environment based on the at least one of the one or more cells comprising the first indication.

Clause 23. The UE of clause 17, wherein the means for determining the one or more cells of the position estimation exclusion mask that correspond to the one or more intermediate propagation positions and the given predicted position, comprises: means for matching coordinates of the one or more intermediate propagation positions and coordinates of the given predicted position to coordinates of the one or more cells.

Clause 24. The UE of clause 17, further comprising: means for maintaining the given predicted position in the plurality of predicted positions based on each of the one or more cells comprising the second indication.

Clause 25. A non-transitory processor-readable storage medium comprising processor-readable instructions for determining a position of a user equipment (UE) in an indoor environment using a positioning filter, to cause one or more processors to: determine a plurality of predicted positions for the UE in the indoor environment; for at least one given predicted position of the plurality of predicted positions, determine one or more intermediate propagation positions between a previous position corresponding to the given predicted position and the given predicted position, wherein the one or more intermediate propagation positions represent a straight-line trajectory between the previous position corresponding to the given predicted position and the given predicted position; determine one or more cells of a position estimation exclusion mask that correspond to the one or more intermediate propagation positions and the given predicted position, wherein each cell of the position estimation exclusion mask corresponds to an area in the environment, wherein each cell of the position estimation exclusion mask comprises a first indication based on the area comprising one or more obstacles of a plurality of obstacles in the indoor environment or a second indication based on the area not comprising an obstacle; remove the given predicted position from the plurality of predicted positions based on at least one of the one or more cells comprising the first indication; and determine the position of the UE in the indoor environment based on remaining predicted positions in the plurality of predicted positions.

Clause 26. The non-transitory, processor-readable storage medium of clause 25, wherein the positioning filter comprises a positioning particle filter, wherein the processor-readable instructions to cause the one or more processors to determine the plurality of predicted positions for the UE comprise processor-readable instructions to cause the one or more processors to: determine a plurality of particles, each particle in the plurality of particles representing a potential position for the UE in the indoor environment; and determine a start position and a predicted end position of each particle in the plurality of particles.

Clause 27. The non-transitory, processor-readable storage medium of clause 26, wherein the processor-readable instructions to cause the one or more processors to determine the one or more cells of the position estimation exclusion mask that correspond to the one or more intermediate propagation positions and the given predicted position, and to cause the one or more processors to remove the given predicted position from the plurality of predicted positions, comprise processor-readable instructions to cause the one or more processors to: determine the one or more intermediate propagation positions between the start position and the predicted end position of a given particle of the plurality of particles, wherein the one or more intermediate propagation positions represent the straight-line trajectory between the start position and the predicted end position; determine the one or more cells of the position estimation exclusion mask that correspond to the one or more intermediate propagation positions and the predicted end position of the given particle; and remove the given particle from the plurality of particles based on at least one of the one or more cells comprising the first indication.

Clause 28. The non-transitory, processor-readable storage medium of clause 27, wherein the processor-readable instructions to cause the one or more processors configured to determine the position of the UE in the indoor environment based on the remaining predicted positions in the plurality of predicted positions comprise processor-readable instructions to cause the one or more processors to: determine the position of the UE in the indoor environment based on the remaining particles in the plurality of particles.

Clause 29. The non-transitory, processor-readable storage medium of clause 25, wherein the plurality of obstacles in the indoor environment comprises a plurality of static obstacles.

Clause 30. The non-transitory, processor-readable storage medium of clause 25, wherein the processor-readable instructions to cause the one or more processors configured to remove the given predicted position from the plurality of predicted positions comprise processor-readable instructions to cause the one or more processors to: determine that the straight-line trajectory collides with at least one obstacle in the indoor environment based on the at least one of the one or more cells comprising the first indication.

Clause 31. The non-transitory, processor-readable storage medium of clause 25, wherein the processor-readable instructions to cause the one or more processors configured to determine the one or more cells of the position estimation exclusion mask that correspond to the one or more intermediate propagation positions and the given predicted position comprise processor-readable instructions to cause the one or more processors to: match coordinates of the one or more intermediate propagation positions and coordinates of the given predicted position to coordinates of the one or more cells.

Clause 32. The non-transitory, processor-readable storage medium of clause 25, wherein the processor-readable instructions further cause the one or more processors to: maintain the given predicted position in the plurality of predicted positions based on each of the one or more cells comprising the second indication.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media.

Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of +20% or +10%, +5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

We claim:

1. A method for determining a position of a user equipment (UE) in an indoor environment using a positioning filter, comprising:
determining a plurality of predicted positions for the UE in the indoor environment;
for at least one given predicted position of the plurality of predicted positions, determining one or more intermediate propagation positions between a previous position corresponding to the given predicted position and the given predicted position, wherein the one or more intermediate propagation positions represent a straight-line trajectory between the previous position corresponding to the given predicted position and the given predicted position;
determining one or more cells of a position estimation exclusion mask that correspond to the one or more intermediate propagation positions and the given predicted position, wherein each cell of the position estimation exclusion mask corresponds to an area in the indoor environment, wherein each cell of the position estimation exclusion mask comprises a first indication based on the area comprising one or more obstacles of a plurality of obstacles in the indoor environment or a second indication based on the area not comprising an obstacle;
removing the given predicted position from the plurality of predicted positions based on at least one of the one or more cells comprising the first indication; and
determining the position of the UE in the indoor environment based on remaining predicted positions in the plurality of predicted positions.

2. The method of claim 1, wherein the positioning filter comprises a positioning particle filter, wherein the determining of the plurality of predicted positions for the UE, comprises:
determining a plurality of particles, each particle in the plurality of particles representing a potential position for the UE in the indoor environment; and
determining a start position and a predicted end position of each particle in the plurality of particles.

3. The method of claim 2, wherein the determining of the one or more cells of the position estimation exclusion mask that correspond to the one or more intermediate propagation positions and the given predicted position and the removing of the given predicted position from the plurality of predicted positions, comprise:
determining the one or more intermediate propagation positions between the start position and the predicted end position of a given particle of the plurality of particles, wherein the one or more intermediate propagation positions represent the straight-line trajectory between the start position and the predicted end position;
determining the one or more cells of the position estimation exclusion mask that correspond to the one or more intermediate propagation positions and the predicted end position of the given particle; and
removing the given particle from the plurality of particles based on at least one of the one or more cells comprising the first indication.

4. The method of claim 3, wherein the determining of the position of the UE based on the remaining predicted positions in the plurality of predicted positions, comprises: determining the position of the UE based on the remaining particles in the plurality of particles.

5. The method of claim 1, wherein the plurality of obstacles in the indoor environment comprises a plurality of static obstacles.

6. The method of claim 1, wherein the removing of the given predicted position from the plurality of predicted positions comprises: determining that the straight-line trajectory collides with at least one obstacle in the indoor environment based on the at least one of the one or more cells comprising the first indication.

7. The method of claim 1, wherein the determining of the one or more cells of the position estimation exclusion mask that correspond to the one or more intermediate propagation positions and the given predicted position, comprises: matching coordinates of the one or more intermediate propagation positions and coordinates of the given predicted position to coordinates of the one or more cells.

8. The method of claim 1, further comprising: maintaining the given predicted position in the plurality of predicted positions based on each of the one or more cells comprising the second indication.

9. A user equipment (UE) for determining a position of the UE in an indoor environment using a positioning filter, comprising:
one or more memories; and
one or more processors communicatively coupled to the one or more memories, the one or more processors being configured to:
determine a plurality of predicted positions for the UE in the indoor environment;
for at least one given predicted position of the plurality of predicted positions, determine one or more intermediate propagation positions between a previous position corresponding to the given predicted position and the given predicted position, wherein the one or more intermediate positions represent a straight-line trajectory between the previous position corresponding to the given predicted position and the given predicted position;
determine one or more cells of a position estimation exclusion mask that correspond to the one or more intermediate propagation positions and the given predicted position, wherein each cell of the position estimation exclusion mask corresponds to an area in the indoor environment, wherein each cell of the position estimation exclusion mask comprises a first indication based on the area comprising one or more obstacles of a plurality of obstacles in the indoor environment or a second indication based on the area not comprising an obstacle;
remove the given predicted position from the plurality of predicted positions based on at least one of the one or more cells comprising the first indication; and
determine the position of the UE in the indoor environment based on remaining predicted positions in the plurality of predicted positions.

10. The UE of claim 9, wherein the positioning filter comprises a positioning particle filter, wherein the one or more processors configured to determine the plurality of predicted positions for the UE are further configured to:
determine a plurality of particles, each particle in the plurality of particles representing a potential position for the UE in the indoor environment; and
determine a start position and a predicted end position of each particle in the plurality of particles.

11. The UE of claim 10, wherein the one or more processors configured to determine the one or more cells of the position estimation exclusion mask that correspond to the one or more intermediate propagation positions and the given predicted position, and configured to remove the given predicted position from the plurality of predicted positions, are further configured to:
determine the one or more intermediate propagation positions between the start position and the predicted end position of a given particle of the plurality of particles, wherein the one or more intermediate propagation positions represent the straight-line trajectory between the start position and the predicted end position;
determine the one or more cells of the position estimation exclusion mask that correspond to the one or more intermediate propagation positions and the predicted end position of the given particle; and
remove the given particle from the plurality of particles based on at least one of the one or more cells comprising the first indication.

12. The UE of claim 11, wherein the one or more processors configured to determine the position of the UE based on the remaining predicted positions in the plurality of predicted positions are further configured to: determine the position of the UE based on the remaining particles in the plurality of particles.

13. The UE of claim 9, wherein the plurality of obstacles in the indoor environment comprises a plurality of static obstacles.

14. The UE of claim 9, wherein the one or more processors configured to remove the given predicted position from the plurality of predicted positions are further configured to: determine that the straight-line trajectory collides with at least one obstacle in the indoor environment based on the at least one of the one or more cells comprising the first indication.

15. The UE of claim 9, wherein the one or more processors configured to determine the one or more cells of the position estimation exclusion mask that correspond to the one or more intermediate propagation positions and the given predicted position are further configured to: match coordinates of the one or more intermediate propagation positions and coordinates of the given predicted position to coordinates of the one or more cells.

16. The UE of claim 9, wherein the one or more processors are further configured to: maintain the given predicted position in the plurality of predicted positions based on each of the one or more cells comprising the second indication.

17. A user equipment (UE) for determining a position of the UE in an indoor environment using a positioning filter, comprising:
means for determining a plurality of predicted positions for the UE in the indoor environment;
means for, for at least one given predicted position of the plurality of predicted positions, determining one or more intermediate propagation positions between a previous position corresponding to the given predicted position and the given predicted position, wherein the one or more intermediate positions represent a straight-line trajectory between the previous position corresponding to the given predicted position and the given predicted position; means for determining one or more cells of a position estimation exclusion mask that correspond to the one or more intermediate propagation positions and the given predicted position, wherein each cell of the position estimation exclusion mask corresponds to an area in the environment, wherein each cell of the position estimation exclusion mask comprises a first indication based on the area comprising one or more obstacles of a plurality of obstacles in the indoor environment or a second indication based on the area not comprising an obstacle;
means for removing the given predicted position from the plurality of predicted positions based on at least one of the one or more cells comprising the first indication; and
means for determining the position of the UE in the indoor environment based on remaining predicted positions in the plurality of predicted positions.

18. The UE of claim 17, wherein the positioning filter comprises a positioning particle filter, wherein the means for determining the plurality of predicted positions for the UE, comprises:
means for determining a plurality of particles, each particle in the plurality of particles representing a potential position for the UE; and
means for determining a start position and a predicted end position of each particle in the plurality of particles.

19. The UE of claim 18, wherein the means for determining the one or more cells of the position estimation exclusion mask that correspond to the one or more intermediate propagation positions and the given predicted position and the means for removing the given predicted position from the plurality of predicted positions, comprise:
means for determining the one or more intermediate propagation positions between the start position and the predicted end position of a given particle of the plurality of particles, wherein the one or more intermediate propagation positions represent the straight-line trajectory between the start position and the predicted end position;
means for determining the one or more cells of the position estimation exclusion mask that correspond to the one or more intermediate propagation positions and the predicted end position of the given particle; and
means for removing the given particle from the plurality of particles based on at least one of the one or more cells comprising the first indication.

20. The UE of claim 19, wherein the means for determining the position of the UE based on the remaining predicted positions in the plurality of predicted positions, comprises: means for determining the position of the UE based on the remaining particles in the plurality of particles.
